(19) United States
(12) Patent Application Publication
(10) Pub. No.: US 2020/0000044 A1
(43) Pub. Date: Jan. 2, 2020

(54) Device for killing wood-eating insects

(71) Applicants: Alain Salou, Hambach (FR); Alexandre Salou, Hambach (FR)

(72) Inventors: Alain Salou, Hambach (FR); Alexandre Salou, Hambach (FR)

(21) Appl. No.: 16/537,120

(22) Filed: Aug. 9, 2019

(30) Foreign Application Priority Data
Feb. 10, 2017 (FR) PCT/FR2017/000027

(51) Int. Cl. A01G 7/06; A01N 59/16; A01N 59/08; A01M 1/20

(52) U.S. Cl. CPC A01G 7/06; A01M 1/2061; A01N 59/08; A01N 59/16

(57) ABSTRACT

A device for killing wood-eating insects, of the red palm weevil type, or killer bacteria, Xylella fastidiosa, carried by a piercing-sucking insect vector, found on plants, in the trunks of trees, palm trees, olive trees, fruit-bearing trees, resulting in the decay of same.

### RELATED APPLICATION

This application is related to and claims the benefit of priority of International Application No. PCT/FR2017/000027, entitled, “Device for killing wood-eating insects”, filed on Feb. 10, 2017, which is hereby incorporated by reference.

### BACKGROUND INFORMATION

### 1. Field

The present disclosure relates generally to agriculture and in particular to reducing damage to trees caused by weed eating insects.

### 2. Background

Macrotoma serripes, sinoxylons, platimus erichsoni, or insects, piercing-sucking vectors, leafhoppers, spittlebugs, euscelis, carriers of and responsible for the spread of the Xylella fastidiosa killer bacteria, pathogenic element responsible for the decay of olive trees currently, in Italy, in Corsica; Pierce's disease for vines; chlorosis on citrus fruits. Primarily, the bacteria for olive trees, red palm weevils for palm trees-which also attack almond trees, oleander, orange trees, apricot trees, peach trees, vines—is especially virulent, causing highly epidemic diseases through many vectors. Only the eradication or confinement of the contaminated zone with removal and destruction of affected plants currently yields encouraging results for these vector or wood-eating insects, which are only able to fly over short distances.

### SUMMARY

An embodiment of the present disclosure provides a device for treating plants or trees infected by wood-eating insects or killer bacteria, characterized in that it comprises an acid causing, on a metal, an exothermal reaction dissolving the starch, cellulose, releasing an extremely hygroscopic, hydrophilic agent in the treated zone that is toxic for the bacteria and the wood-eating insects.

The agent resulting from the exothermal reaction is a chlorinated compound, ZnCl₂, completed by a chlorinated hydrogen fog, gas with strong molecular agitation that will rise in the infected rising galleries and microcracks. The acid used is hydrochloric acid HCl, and the metal is zinc. The metal is zinc doped with other insecticidal compounds. The insecticidal compounds are selected from one of potassium, copper, sodium, and a hydrocarbon compound.

Another embodiment of the present disclosure provides a device for treating plants, trees infected by wood-eating insects or bacteria, characterized in that it comprises drilling means, a metal, then an acid that, once located in the drilled zone to be treated of a plant, in the center of the trunk, cause an exothermal chemical reaction inside the plant or the trunk, instantaneously, simultaneously generating a pressurized gas and an aggressive hygroscopic agent in the form of an infiltrating fog, propelled and dispersed by the pressure of the gas, drying out the living cells housed in the rising galleries and dissolving the cellulose and the starch on which the parasites feed.

The acid used is hydrochloric acid HCl, and the metal is zinc Zn. The metal is zinc Zn that is doped by one of other metal derivatives acting as reagent for the acid and fixers over time and a hydrocarbon compound.

The doping metal derivatives acting as fixers are copper sulfate, sodium fluoride, potassium bichromate. The doping metal derivatives acting as fixers are associated with a hydrocarbon compound. The propellant gas is hydrogen and the created hygroscopic fog is zinc chloride, or a derivative generated inside the infected plant by the exothermal reaction of an acid on a metal.

The features and functions can be achieved independently in various embodiments of the present disclosure or may be combined in yet other embodiments in which further details can be seen with reference to the following description and drawings.

### BRIEF DESCRIPTION OF THE DRAWINGS

The novel features believed characteristic of the illustrative embodiments are set forth in the appended claims. The illustrative embodiments, however, as well as a preferred mode of use, further objectives and features thereof, will best be understood by reference to the following detailed description of an illustrative embodiment of the present disclosure when read in conjunction with the accompanying drawings, wherein:

FIG. 1 is an illustration of a device for treating plants or trees infected by wood-eating insects or killer bacteria in accordance with an illustrative embodiment.

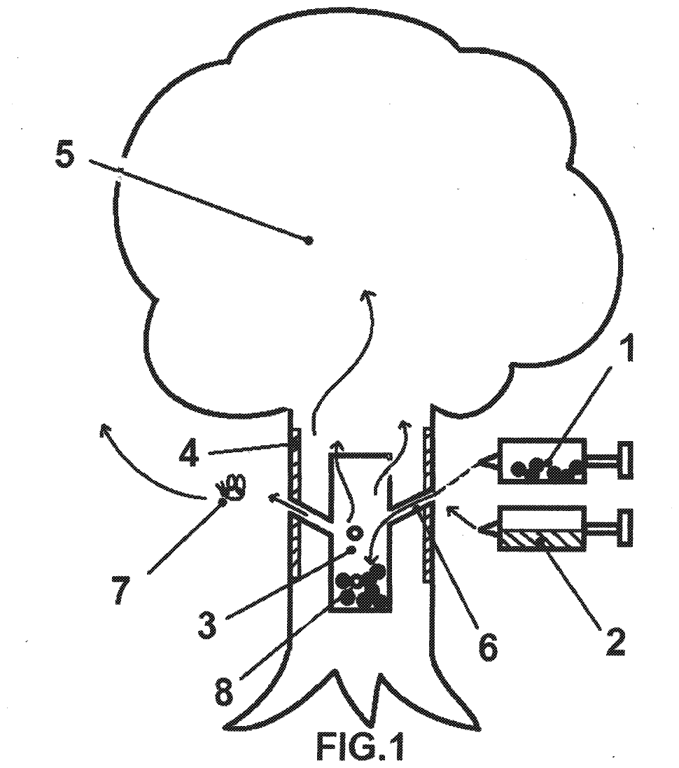

### DETAILED DESCRIPTION

The present invention relates to a device making it possible to treat a tree 5 or plant infected with wood-eating insects, of the red palm weevil type for palm trees; Macrotoma serripes, sinoxylons, platimus erichsoni, or insects, piercing-sucking vectors, leafhoppers, spittlebugs, euscelis, carriers of and responsible for the spread of the Xylella fastidiosa killer bacteria, pathogenic element responsible for the decay of olive trees currently, in Italy, in Corsica; Pierce's disease for vines; chlorosis on citrus fruits. Primarily, the bacteria for olive trees, red palm weevils for palm trees—which also attack almond trees, oleander, orange trees, apricot trees, peach trees, vines—is especially virulent, causing highly epidemic diseases through many vectors. Only the eradication or confinement of the contaminated zone with removal and destruction of affected plants currently yields encouraging results for these vector or wood-eating insects, which are only able to fly over short distances. The known devices for eradicating these insects or bacteria have proven relatively ineffective against infection, since these parasites take refuge in the center of the trunk, microcracks or relatively inaccessible rising galleries; their descendants may reach 1,000 eggs per female in the case of the red palm weevil, which will produce larvae that will suck the sap through hard-to-access galleries dug from the inside, fifty eggs per egg-laying in the case of the leafhopper without counting the killer bacteria conveyed; at this time there is no curative means to combat them, the known insecticides being ineffective, and all that remains is to tear out and destroy plants contaminated by the insects. Symptoms: for fruit trees, the tree appears to lose sap through the bark at the trunk, and the main branches, creating bumps below the bark and light yellow transparent plaques of variable thickness on the bark, which in fact is not sap but natural gum with a viscous appearance hardening gradually when exposed to air; this is a defensive reaction by the tree to a parasite attack from insects of the xyleborus type; although the circulation of the sap is done through the living part located just below the bark, which can be treated using phytosanitary products, the wood-eating insects and killer bacteria take refuge in the dead wood, which is problematic, since there is no known treatment in this case, and the tree becomes structurally weaker, and is doomed in the medium or long term.

The present invention makes it possible to eradicate all of these infections that are decimating our plant heritage, the active treatment ingredient acting simultaneously by hygroscopic ingredient drying out the infected galleries in the center of the trunk (the proliferation of the bacteria requiring minimal moisture), through its insecticidal action recognized as nontoxic for humans, this active agent infiltrating via the pressure due to the high molecular agitation of the propellant gas in the infected rising microcracks inaccessible by traditional insecticides, which act by gravity, this treatment also simultaneously consuming the residual oxygen contained in the galleries, thus participating in asphyxiating colonizing vectors. The invention applies the principle of a gas with high molecular propellant agitation in the rising micro-galleries that are conventionally inaccessible, an aggressive cleaning agent for the cellulose, and primarily starch that the invaders feed on, an extremely hygroscopic agent, which is toxic for the bacteria and the wood-eating insects, an agent having a corrosive hydrophilic action pumping the water from the cells of the killer agents. The propellant gas with strong diffusion in the thin walls will be 20 hydrogen (H₂), the active ingredient, insecticide, which is very hydrophilic, dissolving the starch (food for the insects), is zinc chloride (ZnCl₂) propelled by an exothermal chemical reaction of type Hcl+Zn doped=ZnCl₂+H₂+. The doping in 1 could be done with copper sulfate, sodium fluoride, sodium chloride, etc., or potassium bichromate acting as fixer over time. The application of the method will be done in several steps, drilling of an inclined hole 6 downward to the center of the trunk in the entry zone of the parasites, injection of zinc particles in suspension into a hydrocarbon-based liquid, by a first syringe 1 or a suitable means, then an injection into the same hole, by a second syringe 2 or a suitable means, of a corrosive product, acid reacting on the metal compound in order to produce the hydrogen propellant gas, the acid of the chemical reaction being able to be hydrochloric acid. The hydrocarbon liquid itself having a recognized insecticidal property, it will make it possible to moderate the exothermal reaction and spread it out over time. The chemical reaction between the first and second injections will take place when the hydrocarbon liquid, which may be fuel oil, releases the metal particles in contact with the acid, the production of the hydrogen gas acting as propellant for the dispersion of the treatment agent, resulting from the chemical reaction; this agent will then fill the dead part, the central part 3 of the infected tree or the plant, with an acidic, hydrophilic, rising hot fog of ZnCl₂ first due to the aforementioned invading exothermal chemical reaction while rising through all of the infected microporosities or the vertical galleries hollowed out for egg-laying by the insects, from the inside of the trunk or annular spaces, by the larvae to suck the sap 4, then metamorphose before taking flight 7, the fog secondly rising upon cooling in the form of avid hydrophilic droplets of moisture 8 dissolving the starch, cellulose, which are toxic for the bacteria or insects, with a residual acidity level from the chemical reaction ultimately intervening to participate in asphyxiating the residual pathogenic organisms. Of course, the main object of the present invention is not limited to the description of this document, but can apply to any treatment operation using a chemical reaction generating a propellant gas, a residual active agent neutralizing diseases or living organisms.

The illustrative examples have a number of different features. A first feature comprises a device for treating plants or trees infected by wood-eating insects or killer bacteria, characterized in that it comprises an acid 2 causing, on a metal 1, an exothermal reaction dissolving the starch, cellulose, releasing an extremely hygroscopic, hydrophilic agent 8 in the treated zone (central part 3) that is toxic for the bacteria and the wood-eating insects.

A first sub feature of the first feature is characterized in that the acid 2 used is hydrochloric acid HCl, and the metal 1 is zinc that may or may not be doped with other insecticidal compounds (potassium, copper, sodium, etc., or a hydrocarbon compound).

A second sub feature of either the first feature of the first sub feature is characterized in that the agent 8 resulting from the exothermal reaction is a chlorinated compound, ZnCl₂, completed by a chlorinated hydrogen fog, gas with strong molecular agitation that will rise in the infected rising galleries and microcracks. The agent 8 can be an extremely hygroscopic, hydrophilic agent; a hygroscopic fog; or some other suitable agent.

A second feature comprises a device for treating plants, trees infected by wood-eating insects or bacteria, characterized in that it comprises drilling means, a metal, then an acid that, once located in the drilled zone to be treated of a plant, in the center of the trunk, cause an exothermal chemical reaction inside the plant or the trunk, instantaneously, simultaneously generating a pressurized gas and an aggressive hygroscopic agent in the form of an infiltrating fog, propelled and dispersed by the pressure of the gas, drying out the living cells housed in the rising galleries and dissolving the cellulose and the starch on which the parasites feed.

A first sub feature of the second feature is characterized in that the propellant gas is hydrogen and the created hygroscopic fog 8 is zinc chloride, or a derivative generated inside the infected plant by the exothermal reaction of an acid on a metal.

A second sub feature of the second feature or the first sub feature is characterized in that the acid 2 used is hydrochloric acid HCl, and the metal 1 is zinc Zn, which may or may not be doped by other metal derivatives acting as reagent for the acid and fixers over time, or a hydrocarbon compound.

A third sub feature of the second sub feature is characterized in that the doping metal derivatives acting as fixers can be copper sulfate, sodium fluoride, etc., potassium bichromate, and may or may not be associated with a hydrocarbon compound.

The description of the different illustrative embodiments has been presented for purposes of illustration and description and is not intended to be exhaustive or limited to the embodiments in the form disclosed. The different illustrative examples describe components that perform actions or operations. In an illustrative embodiment, a component can be configured to perform the action or operation described. For example, the component can have a configuration or design for a structure that provides the component an ability to perform the action or operation that is described in the illustrative examples as being performed by the component.

Many modifications and variations will be apparent to those of ordinary skill in the art. Further, different illustrative embodiments may provide different features as compared to other desirable embodiments. The embodiment or embodiments selected are chosen and described in order to best explain the principles of the embodiments, the practical application, and to enable others of ordinary skill in the art to understand the disclosure for various embodiments with various modifications as are suited to the particular use contemplated.

What is claimed is:

1. A device for treating plants or trees infected by wood-eating insects or killer bacteria, characterized in that it comprises an acid causing, on a metal, an exothermal reaction dissolving the starch, cellulose, releasing an extremely hygroscopic, hydrophilic agent in the treated zone that is toxic for the bacteria and the wood-eating insects.

2. The device according to claim 1, characterized in that the agent resulting from the exothermal reaction is a chlorinated compound, ZnCl₂, completed by a chlorinated hydrogen fog, gas with strong molecular agitation that will rise in the infected rising galleries and microcracks.

3. The device according to claim 1, characterized in that the acid used is hydrochloric acid HCl, and the metal is zinc.

4. The device according to claim 3, characterized in that the agent resulting from the exothermal reaction is a chlorinated compound, ZnCl₂, completed by a chlorinated hydrogen fog, gas with strong molecular agitation that will rise in the infected rising galleries and microcracks.

5. The device according to claim 3, characterized in that the metal is zinc that is doped with other insecticidal compounds.

6. The device according to claim 5, characterized in that the insecticidal compounds are selected from one of potassium, copper, sodium, and a hydrocarbon compound.

7. The device according to claim 5, characterized in that the agent resulting from the exothermal reaction is a chlorinated compound, ZnCl₂, completed by a chlorinated hydrogen fog, gas with strong molecular agitation that will rise in the infected rising galleries and microcracks.

8. A device for treating plants, trees infected by wood-eating insects or bacteria, characterized in that it comprises drilling means, a metal, then an acid that, once located in the drilled zone to be treated of a plant, in the center of the trunk, cause an exothermal chemical reaction inside the plant or the trunk, instantaneously, simultaneously generating a pressurized gas and an aggressive hygroscopic agent in the form of an infiltrating fog, propelled and dispersed by the pressure of the gas, drying out the living cells housed in the rising galleries and dissolving the cellulose and the starch on which the parasites feed.

9. The device according to claims 8, characterized in that the acid used is hydrochloric acid HCl, and the metal is zinc Zn.

10. The device according to claim 9, characterized in that the metal is zinc Zn that is doped by one of other metal derivatives acting as reagent for the acid and fixers over time and a hydrocarbon compound.

11. The device according to claim 10, characterized in that the doping metal derivatives acting as fixers are copper sulfate, sodium fluoride, potassium bichromate.

12. The device according to claim 10, characterized in that the doping metal derivatives acting as fixers are associated with a hydrocarbon compound.

13. The device according to claim 8, characterized in that the propellant gas is hydrogen and the created hygroscopic fog is zinc chloride, or a derivative generated inside the infected plant by the exothermal reaction of an acid on a metal.

14. The device according to claim 13, characterized in that the acid used is hydrochloric acid HCl, and the metal is zinc Zn.

15. The device according to claim 14, characterized in that the metal is zinc Zn that that doped by one of other metal derivatives acting as reagent for the acid and fixers over time and a hydrocarbon compound.

16. The device according to claim 15, characterized in that the doping metal derivatives acting as fixers are copper sulfate, sodium fluoride, and potassium bichromate.

17. The device according to claim 15, characterized in that the doping metal derivatives acting as fixers are associated with a hydrocarbon compound.
